(19) United States
(12) Patent Application Publication
(10) Pub. No.: US 2007/0153096 A1
(43) Pub. Date: Jul. 5, 2007

(54) Imaging apparatus and imaging method

(75) Inventors: Akira Hamano, Kanagawa (JP); Hiroyuki Kinoshita, Tokyo (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 11/601,587

(22) Filed: Nov. 17, 2006

(30) Foreign Application Priority Data
Nov. 17, 2005 (JP) P2005-332282

(51) Int. Cl. H04N 5/76

(52) U.S. Cl. 348/231.99

(57) ABSTRACT

An imaging apparatus for imaging an image using a solid-state imaging device includes a plurality of processing blocks operable to perform predetermined signal processing on an image signal obtained by imaging a subject; a memory operable to store image data; and a control circuit operable to selectively control a plurality of image processing modes, the image processing modes including a moving-image processing mode for processing a moving image using at least one of the processing blocks, a still-image processing mode for processing a still image, the still image processing mode including a frame image generation process using signal processing by at least one of the processing blocks and the memory, and a predetermined image processing mode for processing a predetermined image using at least a part of a sequence performed in the moving-image processing mode and at least a part of a sequence performed in the still-image processing mode, and using at least one of the processing blocks and the memory.

### CROSS-REFERENCE TO RELATED APPLICATIONS

The present application claims priority from Japanese Patent Application No. JP 2005-332282 filed on Nov. 17, 2005, the disclosure of which is hereby incorporated by reference herein.

### BACKGROUND OF THE INVENTION

1. Field of the Invention

The present invention relates to imaging apparatus and an imaging method, and in particular to imaging apparatus and an imaging method for imaging an image using a solid-state imaging device.

2. Related Art

An imaging apparatus, which obtains a digital video signal by imaging an image using a solid-state imaging device such as a charge-coupled device (CCD) sensor or a complementary metal-oxide semiconductor (CMOS) sensor, and records or reproduces the digital video signal as a moving image or a still image via a recording medium, is widely known (see JP-A-2002-44531 for example).

In signal processing of existing imaging apparatus, an image signal output from the CCD or CMOS sensor is input to a camera signal processing large-scale integration (LSI) circuit after A/D conversion, and various correction processes, a luminance process, a color difference process, a resolution conversion process and so on are performed on the image signal in the LSI circuit.

In such imaging apparatus, the image signal read out from the sensor is input to a number of blocks for performing the respective processes, and processed sequentially in an anterior block and then in a posterior block, and accordingly, the flow of the signal is typically one way.

In the imaging apparatus described above, when an operating mode is switched in the device, for example, in the case in which a mode for processing a still image and a mode for processing a certain frame image in a moving image as a still image are selectively used by switching, the order of signal processing might be reversed depending on the modes. However, since the overall delay is affected when the order of the signal processing is changed by switching the operation modes in the apparatus, it is necessary that a dedicated sequence or a dedicated processing circuit is separately provided for each of the modes. Therefore, the control becomes problematically complicated or the scale of the circuit grows problematically.

In view of the above, it is desirable to provide imaging apparatus capable of performing the image processing with simple control. Further, it is also desirable to provide an imaging apparatus and an imaging method capable of performing the image processing according to applications without increasing the circuit scale.

### SUMMARY OF THE INVENTION

According to an embodiment of the invention, there is provided an imaging apparatus for imaging an image using a solid-state imaging device, the apparatus including a plurality of processing blocks operable to perform a predetermined signal processing on an image signal obtained by imaging a subject; a memory operable to store image data; and a control circuit operable to selectively control a plurality of image processing modes, the image processing modes including a moving-image processing mode for processing a moving image using at least one of the processing blocks, a still-image processing mode for processing a still image, the still image processing mode including a frame image generation process using signal processing by at least one of the processing blocks and the memory, and a predetermined image processing mode for processing a predetermined image using at least a part of a sequence performed in the moving-image processing mode and at least a part of a sequence performed in the still-image processing mode, and using at least one of the processing blocks and the memory.

According to the imaging apparatus described above, when a predetermined image processing mode is controlled by the control circuit, the process is performed using a (an existing) processing block and the memory, and in this case, at least a part of a sequence performed in the moving-image processing mode and at least a part of a sequence performed in the still-image processing mode are used.

In an embodiment of the invention, when the predetermined image processing mode is entered, the process is performed using the processing blocks and the memory, and since in this case, at least a part of a sequence performed in the moving-image processing mode and at least a part of a sequence performed in the still-image processing mode are used, the delay control becomes easy, and the image processing can be performed with the simple control. Further, since there is no need for providing any new processing blocks in the apparatus, the image processing in accordance with the purpose of the process can be performed without increasing the size of the circuit.

### BRIEF DESCRIPTION OF THE DRAWINGS

FIG. 1 is a block diagram showing a substantial configuration of imaging apparatus according to an embodiment.

FIG. 2 is a block diagram showing a signal processing circuit of the embodiment.

FIG. 3 is a block diagram showing a correction section of the embodiment.

FIG. 4 is a block diagram showing a correction section of the embodiment.

FIG. 5 is a schematic diagram showing signal flow and the delay thereof in a moving-image mode.

FIG. 6 is a schematic diagram showing signal flow and the delay thereof in a still-image mode.

FIG. 7 is a schematic diagram showing signal flow in a still-image-in-moving-image mode.

FIG. 8 is a diagram for explaining the delay in the still-image-in-moving-image mode.

### DETAILED DESCRIPTION

An embodiment of the invention will hereinafter be described in detail with reference to the accompanying drawings.

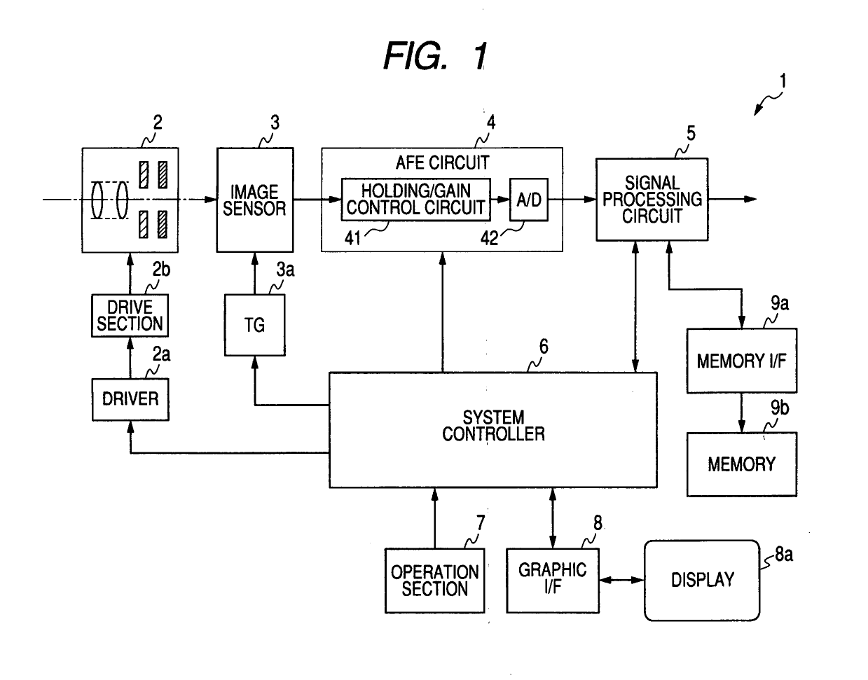

FIG. 1 is a block diagram showing a substantial configuration of imaging apparatus according to the embodiment.

The imaging apparatus shown in FIG. 1 is provided with an optical block 2, a driver 2a, a drive section 2b, an image sensor 3, a timing generation circuit (TG) 3a, an analog front-end (AFE) circuit 4, a signal processing circuit 5, a system controller 6, a operation section 7, a graphic interface (I/F) 8, a display (an image monitor) 8a, memory I/F 9a, and a memory 9b.

The optical block 2 is provided with a lens for collecting incident light from a light source and light (reflected light) from the subject to the image sensor 3, a drive mechanism for performing focusing or zooming by moving the lens, a shutter mechanism, an iris mechanism for determining the amount of light (light amount) passing though the lens, namely the exposure by adjusting an aperture in accordance with the subject illuminance, and so on.

The driver 2a outputs a drive signal for controlling driving of each mechanism in the optical block 2 such as aperture driving in accordance with the control signal from the system controller 6.

The drive section 2b drives the mechanisms in the optical block 2 in response to the drive signals from the driver 2a.

The image sensor 3 is a solid-state imaging device having photo diodes as photoelectric transducers arranged in a matrix, driven in accordance with a timing signal output from the TG 3a, and converts the incident light from the subject into an electric signal. It should be noted that the image sensor is not particularly limited, but CCD, CMOS, and so on can be cited for example.

The TG 3a outputs the timing signal for controlling the electronic shutter under control of the system controller 6.

The AFE circuit 4 includes a holding/gain control circuit 41 and a A/D conversion circuit (A/D) 42. The AFE circuit 4 is composed as a single integrated circuit (IC), wherein the holding/gain control circuit 41 performs a sample/hold process on the image signal output from the image sensor 3 by a correlated double sampling (CDS) process so as to preferably maintain the signal/noise (S/N) ratio, and further, controls the gain by an automatic gain control (AGC) process. Further, the A/D conversion circuit 42 performs the A/D conversion to output the digital image signal. It should be noted that the circuit for performing the CDS process can be formed on the circuit board mounting the image sensor 3 thereon.

The signal processing circuit 5 performs various camera control processes such as an automatic focusing (AF) process, an automatic exposure (AE) process, or an automatic white balance (AWB) process, or a part of such processes on the imaging signal of the subject converted by the AFE circuit 4 into the digital signal in accordance with the control signal from the system controller 6 to generate a picture signal (a luminance signal and a color difference signal) of the subject.

The system controller 6 is a micro controller composed of, for example, a central processing unit (CPU), a read-only memory (ROM), and a random access memory (RAM), and performs the program stored in the ROM or the like in accordance with the calculation results described above to integrally control each part of the imaging apparatus 1 such as the optical block 2, the image sensor 3, the AFE circuit 4, the signal processing circuit 5, and so on, thus performing an automatic control processes of the AF, AE, and AWB, thereby generating the preferable picture signal of the imaging subject.

The operation section 7 includes various operation keys such as a shutter release button, levers, or dials, for example, and outputs a control signal corresponding to an input operation by the user to the system controller 6.

The graphic I/F 8 generates an image signal to be displayed on the display 8a from the image signal supplied from the signal processing circuit 5 via the system controller 6, and supplies the display 8a with the signal to display the image. The display 8a is formed of, for example, a liquid crystal display (LCD), and displays a camera-through image, which is being imaged in real time, a reproduction image based on the data recorded on a recording medium not shown, and so on.

The memory I/F 9a outputs the signal output from the signal processing circuit 5 to the memory 9b after compression encoding depending on the situation. Further the memory I/F 9a outputs the signal output from the memory 9b to the signal processing circuit 5 after decompressing depending on the situation. By compressing the signal, speeding-up of the memory access process can be expected.

The memory 9b is formed of, for example, a synchronous dynamic random access memory (SDRAM).

In the present imaging apparatus 1, the signal received and photoelectric-converted by the image sensor 3 is sequentially supplied to the AFE circuit 4, and is converted into digital signal after the CDS process and the AGC process have been performed thereon. The signal processing circuit 5 converts the digital image signal supplied from the AFE circuit 4 into the luminance signal (Y) and the color difference signals (R−Y, B−Y) while using the memory 9b depending on the situation, and finally outputs it after performing the image quality correction process thereon.

The signal output from the signal processing circuit 5 is supplied to the graphic I/F 8 via the system controller 6 to be converted into the image signal suitable for display, thus the camera-through image is displayed on the display 8a. Further, when image recording is instructed to the system controller 6 by an input operation from the operation section 7 by the user, the image data from the signal processing circuit 5 is supplied to an encoder not shown, and recorded on a recording medium not shown after a predetermined compression encoding process has been perform thereon. When the system controller 6 performs the still-image mode (the still-image processing mode) described later, the signal processing circuit 5 supplies the encoder with the image data for one frame. Further, when the moving-image mode (the moving-image processing mode) is performed, the processed image data is continuously supplied to the encoder.

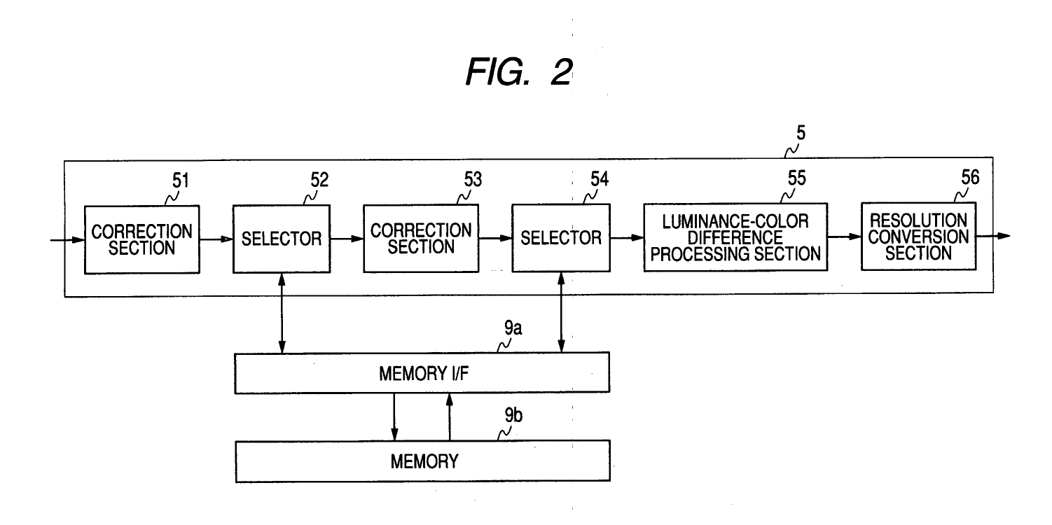

The internal configuration of the signal processing circuit 5 will now be explained in detail. FIG. 2 is a block diagram showing the signal processing circuit.

The signal processing circuit 5 has a correction section (a first correction process block) 51, a selector 52, a correction section (a second correction process block) 53, a selector 54, a luminance-color difference processing section 55, and a resolution conversion section 56 from the left to the right in FIG. 2 in this order.

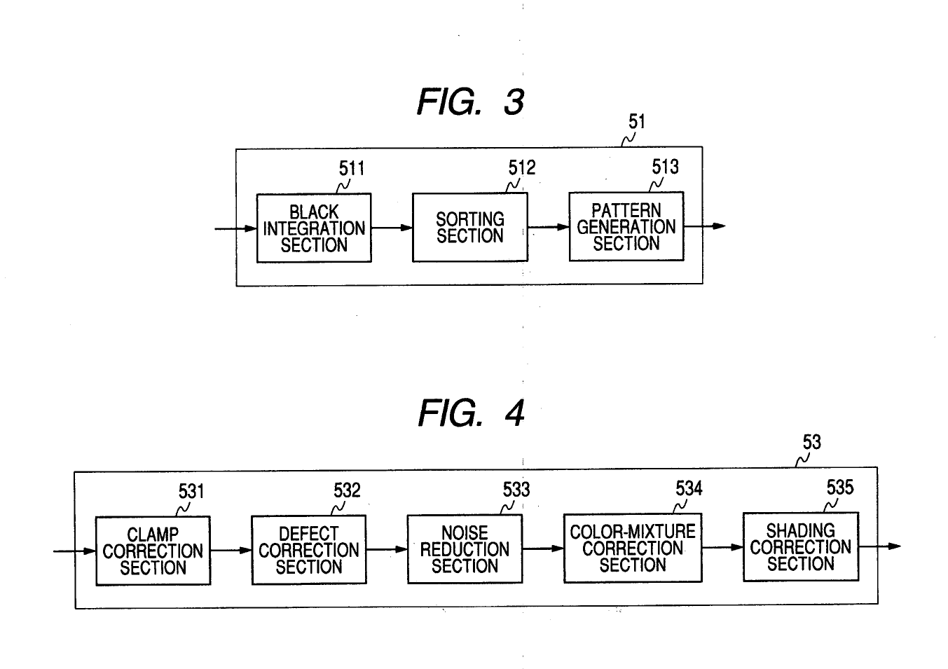

Firstly, the correction section 51 will be explained. FIG. 3 is a block diagram showing the correction section.

The correction section 51 is a region for independently performing the correction operation on the input image signal for every channel, and is provided with a black integration section 511 for detecting a black level, a sorting section 512 for absorbing the difference between the output signals from the sensors to integrate the signals into a single line, and a pattern generation section 513.

The explanation will be continued returning again to FIG. 2.

The selector 52 switches the output destination of the signal output from the correction section 51 according to needs, and outputs it to either one of the correction section 53 and the memory I/F 9a.

FIG. 4 is a block diagram showing the correction section.

The correction section 53 is a region for performing the signal processing between the image signals (using signals of a number of channels), and is provided with a clamp correction section 531 for performing correction of the black level, a defect correction section 532 for correcting a defect on the sensor by the surrounding pixels, a noise reduction section 533 for reducing noisiness of the picture, a color-mixture correction section 534 for correcting the color-mixture of a pixel, and a shading correction section 535 for correcting light amount drop in the environment by the lens and so on. It should be noted that the correction section 51 and the correction section 53 can include other blocks for respectively performing predetermined processes.

The explanation will be continued returning again to FIG. 2.

The selector 54 switches output destination of the signal output from the correction section 53 according to needs, and outputs it either one of the luminance-color difference processing section 55 and the memory I/F 9a.

The luminance-color difference processing section 55 generates the picture signal composed of the luminance signal (Y) and the color difference signals (R−Y, B−Y) from the image signal input thereto.

The resolution conversion section 56 performs conversion of the resolution and the process for correcting the distortion on the picture signal of the subject.

Here, the system controller 6 selectively performs three modes, namely the moving-image mode in which priority is given to the processing speed, the still-image mode in which priority is given to the image quality, and the still-image-in-moving-image mode (still-image-in-moving-image process mode) in which the still-image with higher resolution than the resolution of the moving-image while processing the moving-image, in accordance with the request of the user, using the signal processing circuit 5, the memory I/F 9a, and the memory 9b. The signal flow in each of the modes will hereinafter be explained.

Moving-Image Mode

In the moving-image mode, since the image signals are consecutively input to the signal processing circuit 5, by using the black detection value of the previous field image, the correction process can be performed without accessing the memory 9b. Therefore, the image signal passing through the correction section 51 is transmitted to the correction section 53 via the selector 52. Further, when processing the moving-image, the resolution of the output is lowered by, for example, outputting the signals of the pixels in the vertical direction (the same color) after being added by the sensor.

FIG. 5 is a schematic diagram showing signal flow and the delay thereof in the moving-image mode.

In the moving-image mode, the process of the image signal is performed in the correction section 51, the selector 52, the correction section 53, the selector 54, and the luminance-color difference processing section 55 in this order.

Here, a sequence from when the image signal is input to the correction section 51 to when the image signal is input to the correction section 53 is defined as a first moving-image CAM sequence, and a sequence from when the image signal is input to the correction section 53 to when the image signal is input to the luminance-color difference processing section 55 is defined as a second moving-image CAM sequence. Further, an example of the delay (the time necessary for performing each of the first moving-image CAM sequence and the second moving-image CAM sequence) is assumed to be 2V (V: vertical synchronizing signal).

Still-Image Mode

In order for obtaining the still image, the process for every frame corresponding to release of the shutter is required. In the still-image mode, the image signal passing through the correction section 51 is written in the memory 9b via the selector 52. In the still-image mode, by writing it in the memory 9b, the signal from the sensor read in the field process (interlaced scanning) is stored (memorized) in the memory 9b, after generating one frame (sequential scanning) of signal, the still-image process in the correction section 53 can be performed. Further, after previously performing the black detection for one frame, the detection value can be reflected in the image of the same frame.

It should be noted that, although there is no need for performing the process so fast compared to the moving-image mode, and accordingly the process time of the image signal in the still-image mode is not particularly limited, when the process speed of the moving image is, for example, 1/60 second (60 fps), the process is performed more slowly than 1/30 second period (30 fps) for every frame of image, which is a half of the process speed of the moving-image. Further, in the case in which the process is performed more slowly than 1/30 second period (30 fps), the compression and decompression are not performed in the memory I/F 9a.

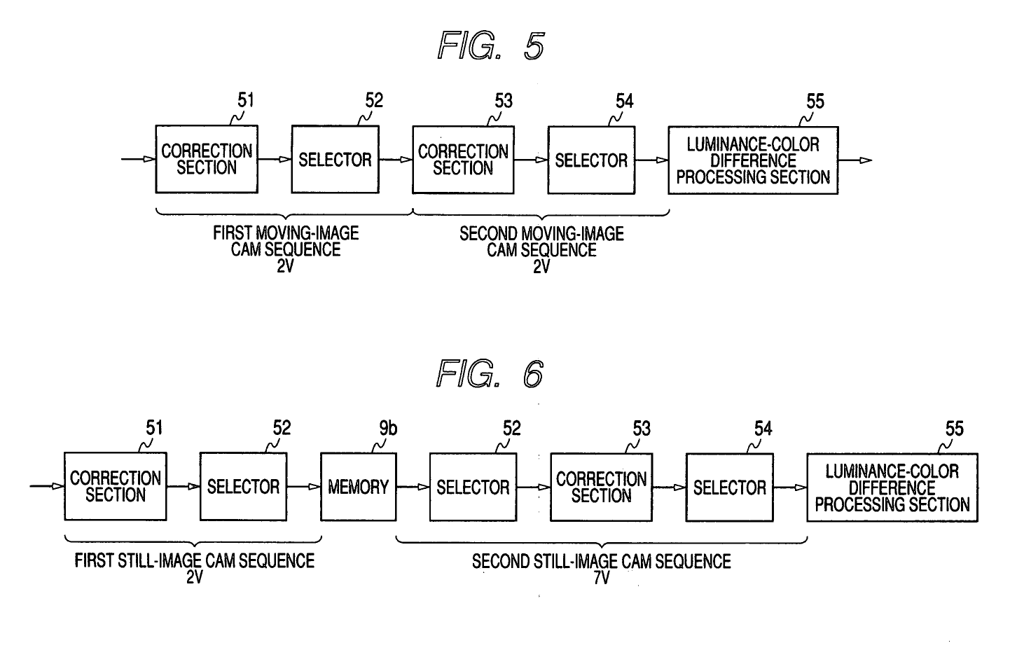

FIG. 6 is a schematic diagram showing signal flow and the delay thereof in the still-image mode.

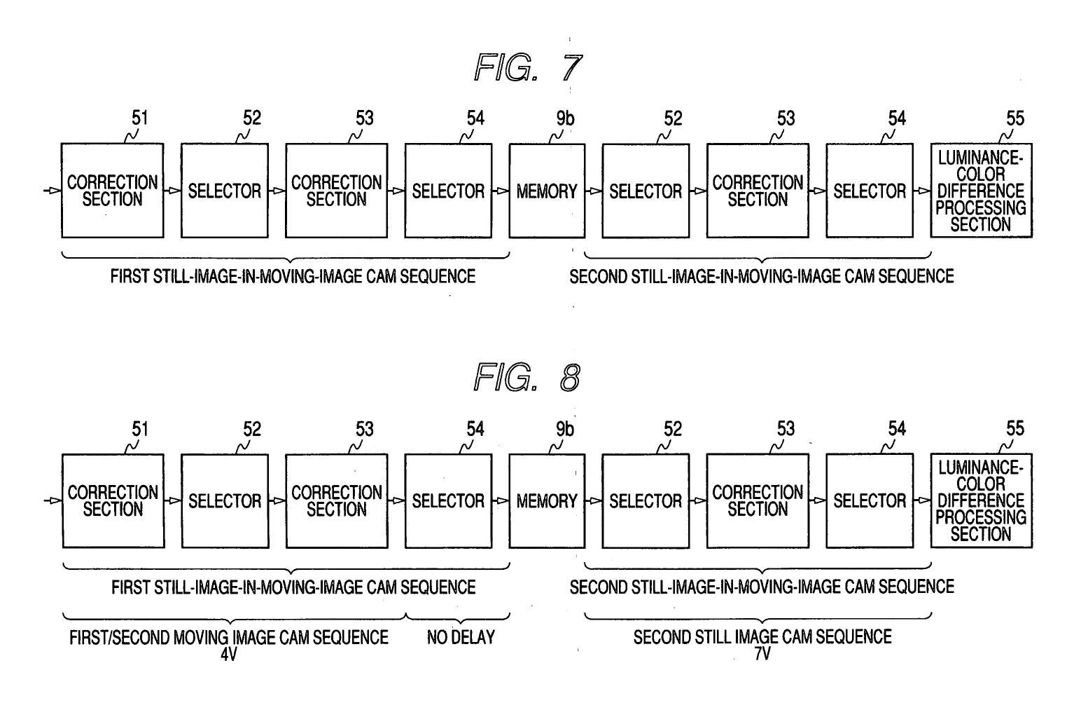

It should be noted that the delay caused between the selector 52 and the memory I/F 9a and the delay caused between the memory I/F 9a and the memory 9b are negligibly small, and accordingly the description of the memory I/F 9a is omitted in FIG. 6 (and FIG. 7 described later).

In the still-image mode, the image signal is processed in the correction section 51, the selector 52, the memory I/F 9a, the memory 9b, the memory I/F 9a, the selector 52, the correction section 53, the selector 54, and the luminance-color difference processing section 55 in this order.

Thus, one frame of the image signal written in the memory 9b is retrieved from the memory 9b back to the selector 52 again, and output to the correction section 53.

In this case, assuming that a sequence from when the image signal is input to the correction section 51 to when the image signal is written in the memory 9b is defined as a first still-image CAM sequence, and a sequence from when the image signal is retrieved from the memory 9b to when the image signal is input to the luminance-color difference processing section 55 is defined as a second still-image CAM sequence, the time necessary for performing the first still-image CAM sequence is 2V, which is the same as in the first moving-image CAM sequence. Further, the time necessary for performing the second still-image CAM sequence is assumed to be 7V, as an example.

Still-Image-In-Moving-Image Mode

As described above, the still-image-in-moving-image mode is a mode for obtaining a still-image with higher resolution than the moving image while processing the moving image. Therefore, since the pixels in the whole area (larger area than in the moving image) of the image sensor 3 is output in the still-image-in-moving-image mode in order to obtain higher resolution than the resolution of the moving image, the number of the pixels is increased in comparison with the moving-image mode.

Further, it is required that, in writing the image signal in the memory 9b, the image signal having higher resolution than the resolution of the moving-image is processed within the time limit of the frame period (in the same processing speed (twice as high as in the still-image mode) as in the moving-image mode, e.g., 1/30 second period (30 fps)).

According to the above reason, in order to store the image signal with the increased number of pixels in the memory 9b, it is necessary to compress the image data before writing it to the memory 9b. The compression method is not particularly limited, but in the case of using typical lossy compression, in comparison between the image signal before compression and the image signal once compressed and then successfully decompressed, the image signal before compression contains greater amount of image information, and accordingly, it is preferable to use the image signal before compression in performing the correction process. Therefore, in the still-image-in-moving-image mode, the various correction operations are performed before compression. Thus, the noise component in the compressed image is reduced.

FIG. 7 is a schematic diagram showing signal flow in the still-image-in-moving-image mode.

In the still-image-in-moving-image mode, the image signal is input to the correction section 53 before inputting in the memory I/F 9a. Specifically, the image signal is processed in the correction section 51, the selector 52, the correction section 53, the selector 54, the memory I/F 9a, the memory 9b, the memory I/F 9a, the selector 52, the correction section 53, the selector 54, and the luminance-color difference processing section 55 in this order.

In this case, in the still-image-in-moving-image mode, it is controlled that the correction operation is only performed when the image signal passes the correction section 53 for the first time, and no process is performed when the image signal passes it for the second time (or later). Thus, duplication of the process can be prevented, and further, generation of any delay can also be prevented.

The delay in the still-image-in-moving-image mode will now be explained.

FIG. 8 is a diagram for explaining the delay in the still-image-in-moving-image mode.

Assuming that a sequence from when the image signal is input to the correction section 51 to when the image signal is written to the memory 9b is defined as a first still-image-in-moving-image CAM sequence, and a sequence from when the image signal is retrieved from the memory 9b to when the image signal is input to the luminance-color difference processing section 55 is defined as a second still-image-in-moving-image CAM sequence, the first still-image-in-moving-image CAM sequence can be realized by diverting the first moving-image CAM sequence and the second moving-image CAM sequence. Further, the second still-image CAM sequence can be diverted into the second still-image-in-moving-image CAM sequence. Therefore, the delay in the first still-image-in-moving-image CAM sequence becomes 4V, which is equal to the sum of the delays in the first and second moving-image CAM sequences. Further, the delay in the second still-image-in-moving-image CAM sequence becomes 7V, which is equal to that of the second still-image CAM sequence. Since the delay from the selector 54 to the memory 9b is negligibly small, the total delay in the still-image-in-moving-image mode becomes 11V.

In the still-image-in-moving-image mode, although it seems that the process becomes simple and preferable by reading the signal from the memory 9b by the selector 54, since there is no such a sequence of accessing the memory 9b via the selector 54 in the existing moving-image mode or the existing still-image mode, the need for newly creating, setting, and controlling the sequence (the system delay) is caused. Therefore, the process becomes complicated, and the circuit configuration also becomes complicated. According to the imaging apparatus 1, the system controller 6 performs control using the sequences of the moving-image mode or the still-image mode (the existing sequences) in performing the still-image-in-moving-image mode. Specifically, the correction process by the correction section 53 is performed before compression to store the result in the memory 9b using the first and second moving-image CAM sequences in the moving-image mode, and the signal output form the memory 9b using the first and second still-image CAM sequences in the still-image mode is output via the selectors 52 through 54.

Thus, since no use of any new sequences is required, the delay control can be simplified, and the system controller 6 can perform the image processing with the simplified control. Further, there is no need for adding any new processing blocks in the signal processing circuit 5 (the imaging apparatus 1) by changing the order of the anterior and posterior process through which the image signal flows. Therefore, the signal processing corresponding to each of the modes can be performed without growing the circuit scale. Further, since the correction process by the correction section 53 is performed before compression, an image composed to be of higher resolution (e.g., substantially the same resolution as the image obtained in the still-image mode) than the resolution of the moving-image can be obtained.

Further, even in the case in which a need for repeatedly performing the process in a certain processing block rises, such a process can be performed by controlling so as to change the sequence of the process to make the signal pass the same process block again without providing another process block for performing the same process.

It should be noted that although in the present embodiment the example of applying a part or the whole of the sequence of the moving-image mode and the still-image mode to the still-image-in-moving-image mode has been described, the embodiment of the invention is not limited thereto, but can be applied to the case, for example, in which a number of modes with different processes are provided in the moving-image mode or the still-image mode.

Although the imaging apparatus and the imaging method according to the invention are described based on the embodiment shown in the accompanying drawings as described above, the invention is not limited to this embodiment, but each of the components can be replaced with one having an identical function and any configurations. Further, any other compositions or steps can be added to the invention.

Further, the invention can be a combination of any two or more of configurations (features) in the embodiment described above.

It should be understood by those skilled in the art that various modifications, combinations, sub-combinations and alterations may occur depending on design requirements and other factors insofar as they are within the scope of the appended claims or the equivalents thereof.

1. An imaging apparatus for imaging an image using a solid-state imaging device, comprising:
a plurality of processing blocks operable to perform predetermined signal processing on an image signal obtained by imaging a subject;
a memory operable to store image data; and
a control circuit operable to selectively control a plurality of image processing modes, the image processing modes including
a moving-image processing mode for processing a moving image using at least one of the processing blocks,
a still-image processing mode for processing a still image, the still-mage processing mode including a frame image generation process using signal processing by at least one of the processing blocks and the memory, and
a predetermined image processing mode for processing a predetermined image using at least a part of a sequence performed in the moving-image processing mode and at least a part of a sequence performed in the still-image processing mode, and using at least one of the processing blocks and the memory.

2. The imaging apparatus according to claim 1,
wherein the predetermined image processing mode is a still-image-in-moving-image processing mode including a frame image generation process using signal processing by at least one of the processing blocks and the memory in a moving-image generation process and for processing a still-image.

3. The imaging apparatus according to claim 2, further comprising
a compression/decompression section operable to compress the image signal to be stored in the memory and to decompress the image signal retrieved from the memory,
wherein the still-image-in-moving-image processing mode processes the still-image-in-moving-image via the compression/decompression section.

4. The imaging apparatus according to claim 3, wherein
the processing blocks include a first correction processing block for independently performing a correction process on the image signal for each channel, and a second correction processing block for performing a correction process on the image signal, on which the process by the first correction processing block is performed, using a plurality of channels,
the moving-image processing mode is a mode for processing the moving image by the first correction processing block and then the second correction processing block,
the still-image processing mode is a mode for storing in the memory the image signal processed by the first correction processing block without being processed by the compression/decompression section, and for processing by the second correction processing block the image signal retrieved from the memory without being processed by the compression/decompression section, and
the still-image-in-moving-image processing mode is a mode for processing by the second correction processing block the image signal processed by the first correction processing block prior to storing the image signal in the memory via the compression/decompression section, and for outputting via the second correction processing block the frame image signal retrieved from the memory.

5. The imaging apparatus according to claim 4,
wherein the still-image-in-moving-image processing mode is a mode for using a sequence performed in the moving-image processing mode when the image signal processed by the first correction processing block is processed by the second correction processing block prior to storing the image signal in the memory via the compression/decompression section, and for using at least a part of a sequence performed in the still-image processing mode when the image signal retrieved from the memory again passes the second correction processing block.

6. The imaging apparatus according to claim 5,
wherein the second correction processing block performs the correction process only when the image signal passes the second correction processing block for the first time.

7. An imaging method for imaging an image using a solid-state imaging device, comprising:
selectively controlling a plurality of image processing modes, the image processing modes including
a moving-image processing mode for processing a moving image using at least one of a plurality of processing blocks each operable to perform predetermined signal processing on an image signal obtained by imaging a subject,
a still-image processing mode for processing a still image, the still-image processing mode including a frame image generation process using signal processing by at least one of the processing blocks and a memory for storing image data, and
a predetermined image processing mode for processing a predetermined image using at least a part of a sequence performed in the moving-image processing mode and at least a part of a sequence performed in the still-image processing mode, and using at least one of the processing blocks or the memory.
